(19) United States
(12) Patent Application Publication
(10) Pub. No.: US 2024/0321566 A1
(43) Pub. Date: Sep. 26, 2024

(54) MASS SPECTROMETER

(71) Applicant: Kioxia Corporation, Tokyo (JP)

(72) Inventors: Jun ASAKAWA, Yokkaichi Mie (JP); Haruko AKUTSU, Yokosuka Kanagawa (JP); Yuki OTSUKA, Yokkaichi Mie (JP)

(73) Assignee: Kioxia Corporation, Tokyo (JP)

(21) Appl. No.: 18/591,293

(22) Filed: Feb. 29, 2024

(30) Foreign Application Priority Data
Mar. 20, 2023 (JP) 2023-044776

(51) Int. Cl. H01J 49/42; H01J 49/00; H01J 49/16

(52) U.S. Cl. CPC H01J 49/426; H01J 49/164; H01J 49/0031

(57) ABSTRACT

A mass spectrometer includes a beam irradiator configured to emit an ion beam with pulses to irradiate a beam irradiation region along a surface of a sample; a laser irradiator configured to emit laser light with pulses to irradiate a laser irradiation region above the sample; a mass spectrometry unit configured to detects a mass of ion particles released from the sample by the ion beam and ionized by the laser light; and a controller. The controller is configured to: adjust a position of the laser irradiation region; and adjust the position of the laser irradiation region for each irradiation interval of the laser light.

### CROSS-REFERENCE TO RELATED APPLICATION

This application is based upon and claims the benefit of priority from Japanese Patent Application No. 2023-044776, filed Mar. 20, 2023, the entire contents of which are incorporated herein by reference.

### FIELD

Embodiments described herein relate generally to a mass spectrometer.

### BACKGROUND

Examples of related art include a mass spectrometer using a sputtered neutral mass spectroscopy (SNMS), as a device for analyzing a mass of an element present in a semiconductor substrate or a film formed on the semiconductor substrate.

### DESCRIPTION OF THE DRAWINGS

FIG. 1 is a block diagram showing a configuration example of a mass spectrometer according to an embodiment of the present disclosure.

FIG. 2 is a diagram showing an observation region set in a sample.

FIG. 3 is a diagram showing a detailed structure of a laser irradiation unit in the embodiment.

FIG. 4 is a diagram showing an electro-optical effect switch.

FIG. 5 is a diagram showing a detailed structure of a laser irradiation unit in a comparative example.

FIG. 6A is a diagram showing a process from sputtering to ionization of a sample.

FIG. 6B is a diagram showing a process from sputtering to ionization of a sample.

FIG. 6C is a diagram showing a process from sputtering to ionization of a sample.

FIG. 6D is a diagram showing a process from sputtering to ionization of a sample.

FIG. 7A is a diagram showing a process from sputtering to ionization of a sample.

FIG. 7B is a diagram showing a process from sputtering to ionization of a sample.

FIG. 7C is a diagram showing a process from sputtering to ionization of a sample.

FIG. 7D is a diagram showing a process from sputtering to ionization of a sample.

FIG. 8 is a timing chart of the operation of each part in the mass spectrometer of the embodiment.

FIG. 9 is a flowchart showing an example of a procedure of an analysis method using the mass spectrometer of the embodiment.

### DETAILED DESCRIPTION

Embodiments provide a mass spectrometer capable of wide-range analysis without increasing detection time while preventing a decrease in detection sensitivity.

In general, according to one embodiment, the mass spectrometer of the present embodiment includes a beam irradiator configured to emit an ion beam with pulses to irradiate a beam irradiation region along a surface of a sample; a laser irradiator configured to emit laser light with pulses to irradiate a laser irradiation region above the sample; a mass spectrometry unit configured to detects a mass of ion particles released from the sample by the ion beam and ionized by the laser light; and a controller. The controller is configured to: adjust a position of the laser irradiation region; and adjust the position of the laser irradiation region for each irradiation interval of the laser light.

Hereinafter, embodiments will be described with reference to the drawings.

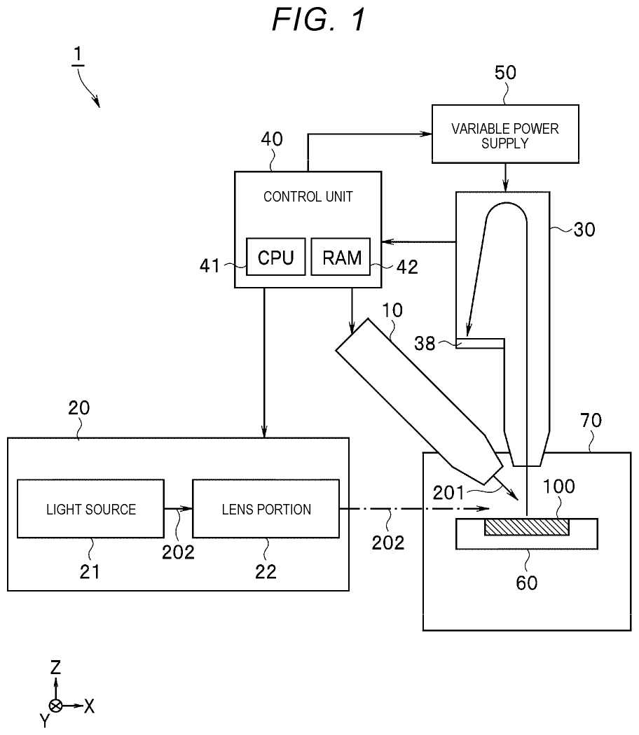

FIG. 1 is a block diagram showing a configuration example of a mass spectrometer according to an embodiment of the present disclosure. The mass spectrometer 1 of the present embodiment is a mass spectrometer using SNMS. As shown in FIG. 1, the mass spectrometer 1 includes a beam irradiation unit (or beam irradiator) 10, a laser irradiation unit (or laser irradiator) 20, a mass spectrometry unit 30, a control unit (or controller) 40, a variable power supply 50, a sample table 60, and a chamber 70.

The beam irradiation unit 10 serving as the ion light source irradiates the sample 100 provided on the sample table 60 with the ion beam 201 in a pulsed manner. The ion beam 201 is, for example, a focused ion beam (FIB) including gallium ions. When the sample 100 is irradiated with the ion beam 201 in the chamber 70 in a vacuum state, the sample is sputtered, and particles are released from the surface of the sample. In the following description, two directions orthogonal to each other in a plane parallel to the surface (surface to be irradiated with the ion beam 201) of the sample 100 provided on the sample table 60 are referred to as an X direction and a Y direction. In addition, a direction perpendicular to the surface of the sample 100 is referred to as a Z direction. In addition, in the following description, a positive side of the Z direction may be referred to as an upper side and a negative side may be referred to as a lower side. The ion beam 201 is emitted to the surface of the sample 100 along the Z direction. The laser irradiation unit 20 has a light source 21 and

a lens portion 22. The light source 21 is, for example, a femtosecond laser light source, and emits the laser light 202 in a pulsed manner. The laser light 202 is focused by the lens portion 22 and is irradiated above the sample 100. The laser light 202 is emitted in parallel with the XY plane. For example, in FIG. 1, the laser light 202 is emitted above the sample 100 along the X direction. The particles released from the sample 100 are ionized by the laser light 202 above the sample 100. Mass spectrometry is performed on the ion particles ionized by the laser light 202 with the mass spectrometry unit 30. The mass spectrometry unit 30 has a micro channel plate (MCP) 38.

The mass spectrometry unit 30 is a reflectron type that causes the ion particles drawn into the mass spectrometry unit to fly so that the direction thereof is reversed in the middle. A plurality of electrodes (not shown) are arranged along a trajectory of the ion particles in the mass spectrometry unit 30. These electrodes are connected to the variable power supply 50. The variable power supply 50 can adjust a voltage to be applied to each electrode based on a control of the control unit 40. The voltage applied to each electrode is adjusted to adjust the trajectory such that the ion particles drawn into the mass spectrometry unit 30 reach the MCP 38.

The MCP 38 amplifies and detects ion particles. The MCP 38 has a plurality of microchannels (through via holes) serving as a secondary electron multiplier tube, and the ion particles that reached the MCP 38 are incident into the microchannels from one opening of each of the microchannels. The ion particles incident into the microchannel collide with an inner wall of the microchannel, and thus two or more secondary electrons are released. The released secondary electrons also collide with the inner wall of the channel, and the release of secondary electrons is further repeated (cascade multiplication of secondary electrons). A large number of secondary electrons cascade-multiplied in this way are released as radiation electrons from the other opening of the microchannel. The secondary electrons released from the microchannel are converted into a digital signal by an AD converter (not shown). The digitized signal is output to the control unit 40.

The control unit 40 includes a central processing unit (CPU) 41 serving as a processor and a RAM 42. The CPU 41 operates in accordance with a program stored in a memory (not shown) and has a control function of controlling the operation and setting of each part (the ion beam irradiation unit 10, the laser irradiation unit 20, the variable power supply 50, and the like) constituting the mass spectrometer 1, and also has a data analysis function of analyzing a signal output from the mass spectrometry unit 30. That is, the signal input from the mass spectrometry unit 30 is analyzed, the elements contained in the sample 100 are identified, and the mass is calculated for each element. The RAM 42 stores the analyzed data and various set values.

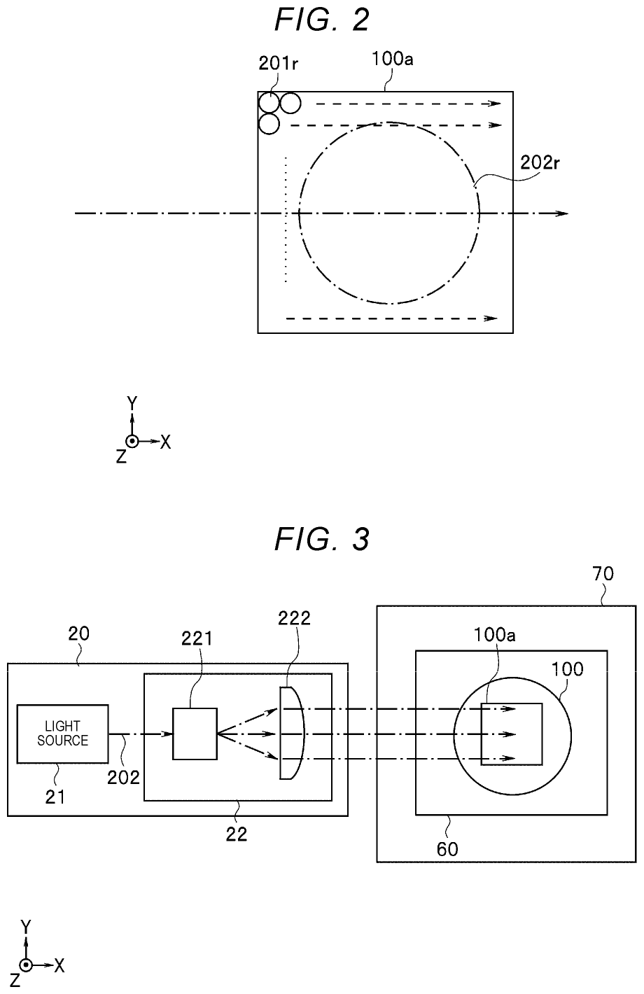

Next, the observation region 100a set in the sample 100 will be described. FIG. 2 is a diagram showing an observation region set in the sample. When the sample 100 is observed, first, the observation region 100a is set in the surface of the sample 100. For example, a rectangular region of 200 μm×200 μm is set as the observation region 100a. A spot 201r, which is an irradiation region of the ion beam 201, is set in the observation region 100a. For example, a size of the spot 201r is approximately several tens of nm to several hundreds of nm. For example, while moving a position of the spot 201r as indicated by the dotted line with an arrow in FIG. 2 by using the raster scan method, the observation region 100a is scanned with the ion beam 201. By such scanning, the entire observation region 100a can be sputtered to release the particles from the surface. Meanwhile, the irradiation region 202r with the laser light is set above the observation region 100a. A high photon density (10¹⁴ W/cm²) is required for a tunnel ionization of the neutral particles. Therefore, the laser light 202 needs to be focused to a diameter of approximately 100 μm and emitted with a short pulse width (for example, approximately 100 fs). Therefore, the irradiation region 202r with the laser light is, for example, a circular region having a diameter of approximately 100 μm centered on the focal position as shown in FIG. 2. The irradiation region 202r has a smaller area than the observation region 100a, and in order to cover the entire spot 201r, it is necessary to perform the analysis while changing the position of the irradiation region 202r according to the position of the spot 201r to be irradiated with the ion beam 201. In order to efficiently ionize the neutral particles released from the surface of the observation region 100a, it is preferable that the photon density of the laser light 202 is high above the spot 201r. The photon density of the laser light 202 in the irradiation region 202r is highest at the focal position and tends to decrease as the distance from the focal position increases. Therefore, when viewed from the Z direction, it is preferable that the spot 201r and the focal position of the laser light 202 coincide with each other.

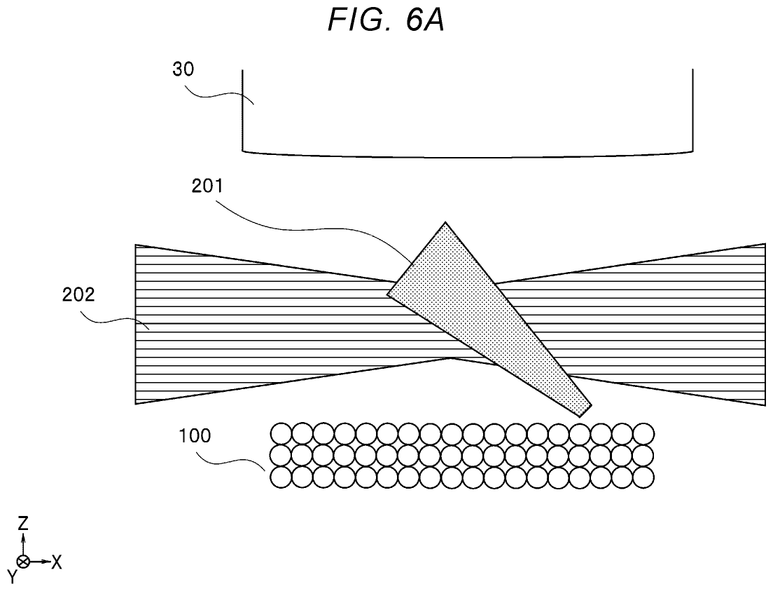

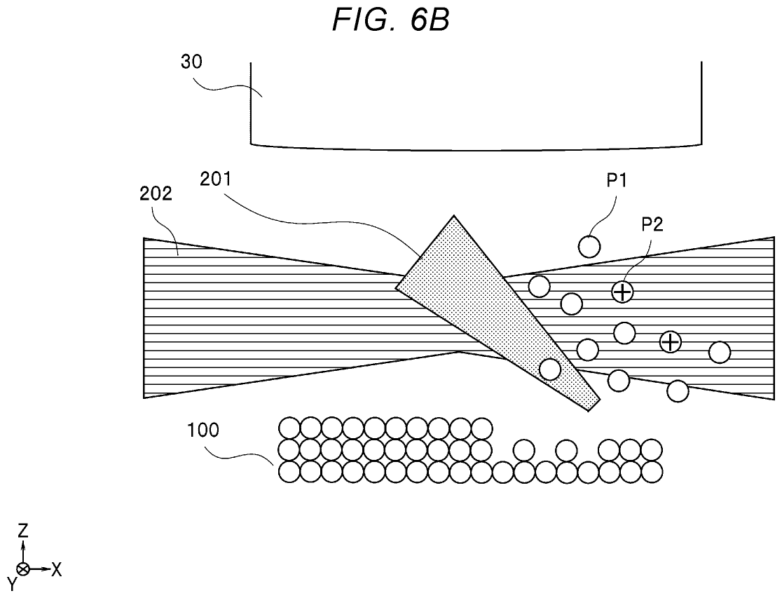

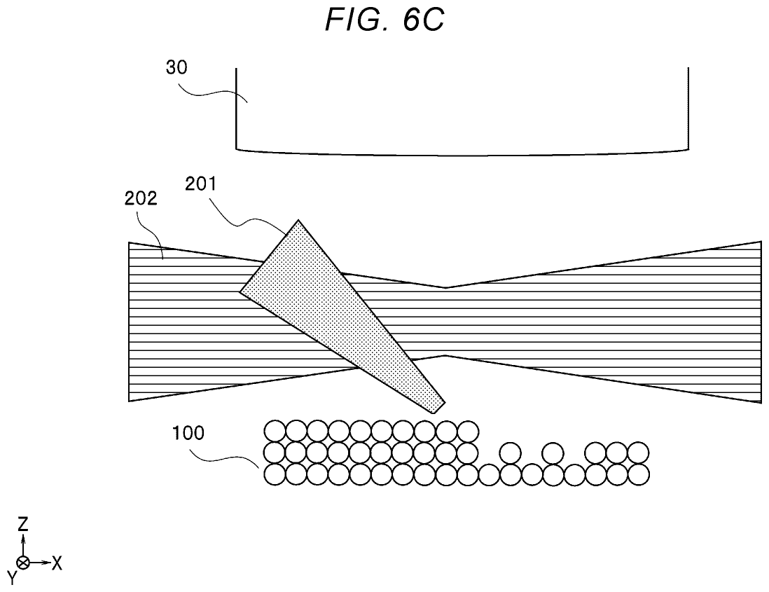

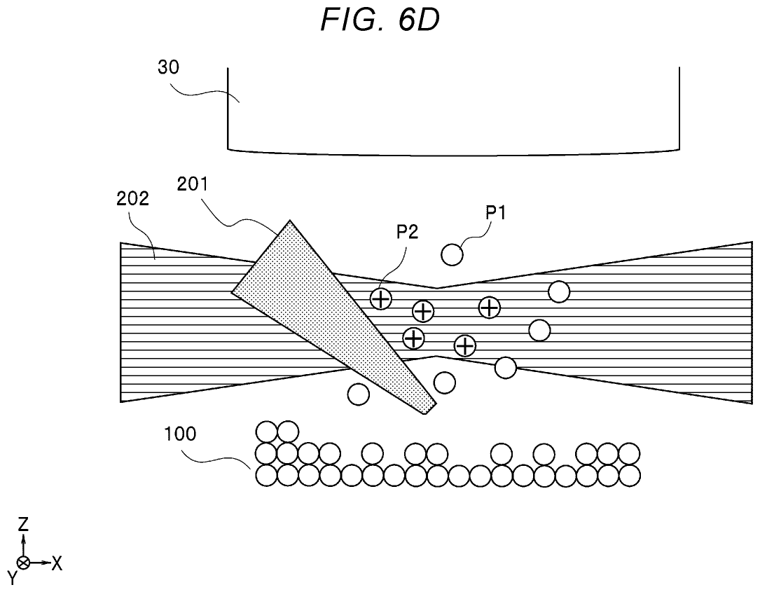

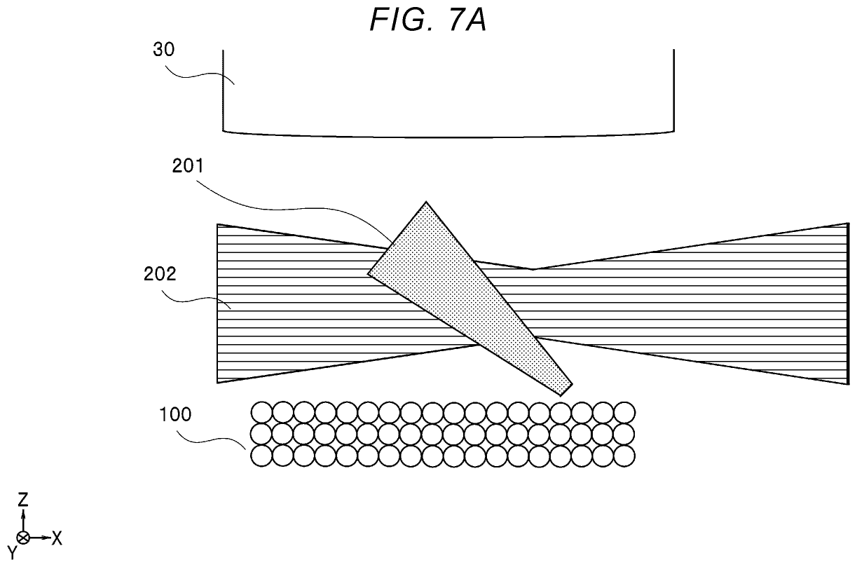

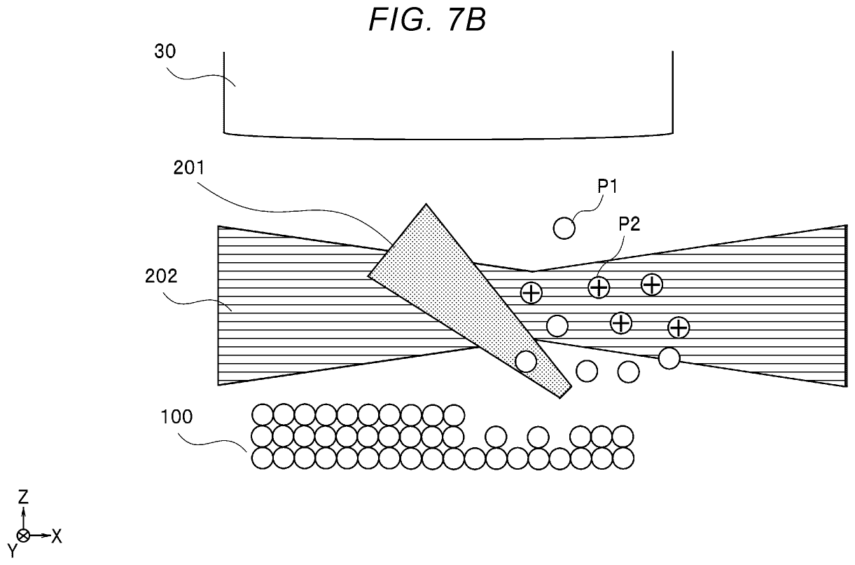

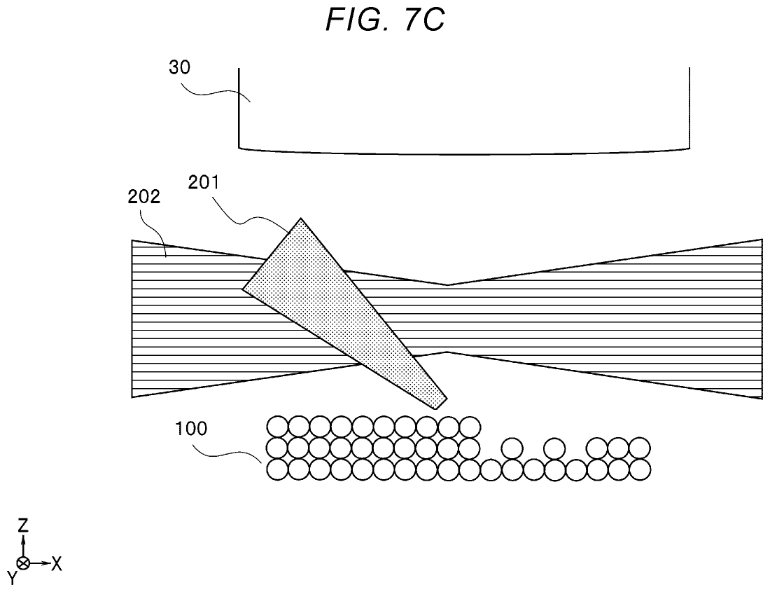

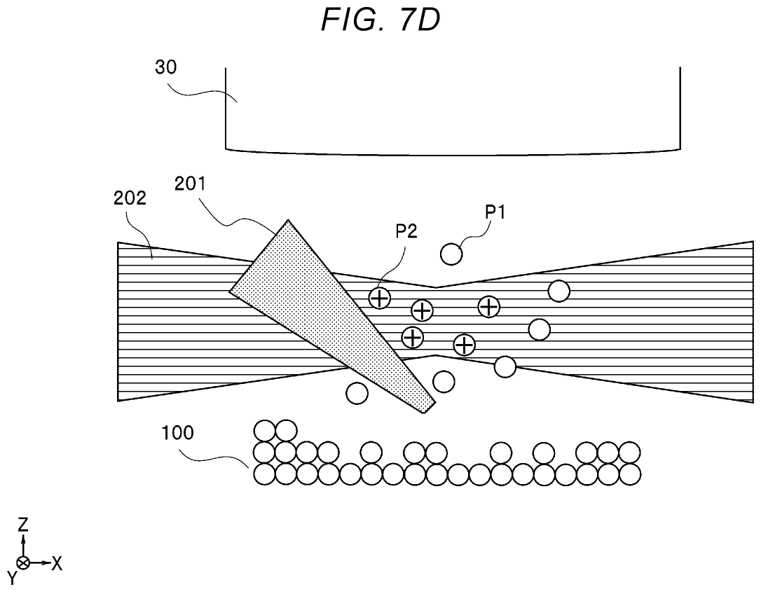

FIGS. 6A to 6D and FIGS. 7A to 7D are diagrams showing a process from sputtering to ionization of the sample. FIGS. 6A to 6D are diagrams showing a case where the analysis is performed without changing the position of the irradiation region 202r. FIGS. 7A to 7D are diagrams showing a case where the analysis is performed while changing the position of the irradiation region 202r. In FIGS. 6A to 6D and FIGS. 7A to 7D, a position where the beam diameter of the laser light 202 is the smallest (a position where the width in the Z direction is the smallest in the drawing) is set as the focal position. In addition, a position where an optical axis of the ion beam 201 intersects the surface of the sample 100 is set as a center position of the spot 201r.

Hereinafter, analysis in a state where the focal position is fixed without changing the position of the irradiation region 202r will be described. First, the surface of the sample 100 is irradiated with the ion beam 201 in a state where the focal position of the laser light 202 and the center position of the spot 201r are shifted from each other (FIG. 6A). When the surface of the sample 100 is sputtered and the particles are released in this state, the particles are ionized by the laser light 202 (FIG. 6B). At this time, a part of the released particles are ionized in accordance with the photon density of the laser light 202 above the spot 201r. That is, a part of the released particles are ionized to become ion particles P2 and drawn into the mass spectrometry unit 30, while the remaining particles are drawn into the mass spectrometry unit 30 as neutral particles P1. FIG. 6B shows a state where the ionization efficiency is approximately 10%, for example. Next, the surface of the sample 100 is irradiated with the ion beam 201 in a state where the position of the spot 201r is moved, and the focal position of the laser light 202 and the center position of the spot 201r coincide with each other (FIG. 6C). When the surface of the sample 100 is sputtered and the particles are released in this state, the particles are ionized by the laser light 202 (FIG. 6D). At this time, the photon density of the laser light 202 above the spot 201r is higher than the photon density in the state shown in FIG. 6B. As the photon density increases, the ionization rate increases. Therefore, the ionization efficiency in the state of FIG. 6D is higher than that in the state of FIG. 6B. FIG. 6D shows a state where the ionization efficiency is approximately 45%, for example.

Next, a case where the analysis is performed while changing the position of the irradiation region 202r will be described. First, the surface of the sample 100 is irradiated with the ion beam 201 in a state where the focal position and the center position of the spot 201r are arranged with each other (FIG. 7A). In this state, when the surface of the sample 100 is sputtered and the particles are released, the particles are ionized by the laser light 202 (FIG. 7B). The state of FIG. 7B is the same as the state of FIG. 6D, and thus the ionization efficiency is also the same (for example, approximately 45%). Next, the position of the spot 201r is moved (FIG. 7C). At this time, the irradiation region 202r of the laser light 202 is also moved such that the focal position of the laser light 202 and the center position of the spot 201r coincide with each other. In this state, when the surface of the sample 100 is sputtered and the particles are released, the particles are ionized by the laser light 202 (FIG. 7D). The state of FIG. 7D is the same as the state in FIG. 7B, and thus the ionization efficiency is also the same (for example, approximately 45%).

When the analysis is performed without changing the position of the irradiation region 202r, the ionization efficiency of the particles released from the sample 100 is changed depending on the position of the spot 201r. As a deviation between the position of the irradiation region 202r and the position of the spot 201r increases, the ionization efficiency decreases. When the ionization efficiency decreases, the number of ion particles that can be detected by the mass spectrometry unit 30 decreases, and thus the detection sensitivity decreases. Meanwhile, when the analysis is performed while changing the position of the irradiation region 202r, a high ionization efficiency can be maintained regardless of the position of the spot 201r. Therefore, the analysis can be performed without decreasing the detection sensitivity.

The mass spectrometer 1 of the embodiment includes a mechanism for adjusting the position of the irradiation region 202r of the laser light 202 in the laser irradiation unit 20. FIG. 3 is a diagram showing a detailed structure of the laser irradiation unit in the embodiment. The lens portion 22 serving as the optical path adjustment unit includes an electro-optical effect switch 221 and an aspherical lens 222. The electro-optical effect switch 221 and the aspherical lens 222 are arranged in this order on the optical path of the laser light 202.

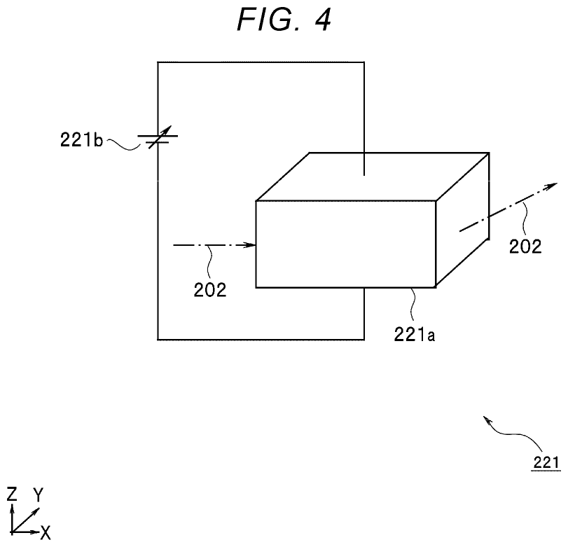

FIG. 4 is a diagram showing an electro-optical effect switch. As shown in FIG. 4, the electro-optical effect switch 221 has an electro-optical crystal 221a and a variable voltage source 221b. More specifically, a variable voltage source 221b is connected to electrodes provided on an upper surface and a lower surface of the electro-optical crystal 221a, respectively. The refractive index of the electro-optical crystal 221a is changed by adjusting the voltage applied to the electro-optical crystal 221a by the variable voltage source 221b. The electro-optical effect switch 221 of the embodiment is, for example, a Pockels cell formed of a BBO crystal which is a barium borate crystal. The Pockels cell changes a refractive index of light transmitted through the cell as a linear function of the applied voltage. That is, by adjusting the voltage applied to the electro-optical crystal 221a by the variable voltage source 221b, the direction of the laser light 202 emitted from the electro-optical crystal 221a can be changed to a direction at a desired angle with respect to the direction of the laser light 202 incident on the electro-optical crystal 221a. That is, the direction of the laser light 202 to be emitted can be changed with respect to the direction of the incident laser light 202 by the electro-optical effect switch 221. The applied voltage to the electro-optical crystal 221a by the variable voltage source 221b is set by, for example, the control unit 40. In addition, the aspherical lens 222 is configured to emit the laser light 202 substantially parallel to the optical axis regardless of the incident position of the laser light 202.

As described above, the laser irradiation unit 20 of the embodiment can change the optical path of the laser light 202 emitted from the light source 21 by using the electro-optical effect switch 221 and the aspherical lens 222. Accordingly, the position of the irradiation region 202r of the laser light 202 on the observation region 100a can be adjusted to a desired position. By adjusting the position of the irradiation region 202r of the laser light 202 in accordance with the movement of the position of the spot 201r, a wide range of analysis can be performed without decreasing the detection sensitivity.

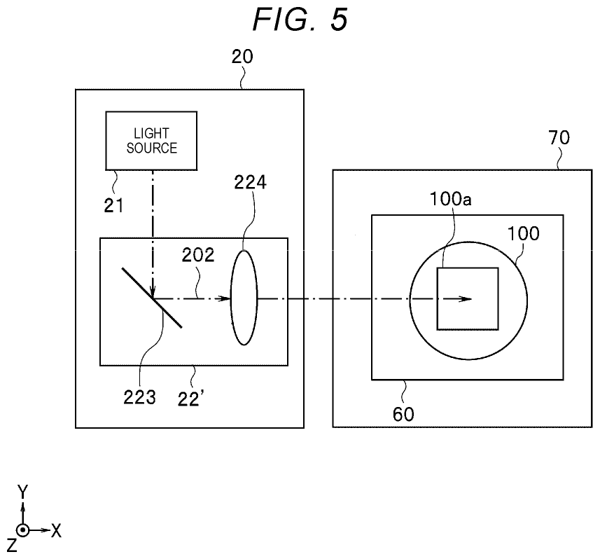

FIG. 5 is a diagram showing a detailed structure of the laser irradiation unit in the comparative example. The lens portion 22′ of the laser irradiation unit 20 of the comparative example includes a mirror 223 and a spherical lens 224. The laser light 202 emitted from the light source 21 passes through the spherical lens 224 after the direction of the optical path is adjusted by the mirror 223, and is emitted toward the focal position on the optical axis. In a case of the structure of the comparative example shown in FIG. 5, when the position of the irradiation region 202r of the laser light 202 is changed, it is necessary to move the position of the mirror 223, change the incident angle of the laser light 202 with respect to the mirror 223, or adjust the position of the spherical lens 224 to change the focal position of the laser light 202. That is, in order to change the position of the irradiation region 202r of the laser light 202, it is necessary to mechanically adjust a disposition of the mirror 223 and the spherical lens 224. Therefore, it takes, for example, approximately several seconds to change the irradiation position of the laser light 202.

In contrast, in the device of the embodiment shown in FIG. 3, the position of the irradiation region 202r of the laser light 202 can be changed by adjusting the voltage applied to the electro-optical crystal 221a. That is, the position of the irradiation region 202r of the laser light 202 can be changed by electrical adjustment. Therefore, for example, the position of the irradiation region 202r of the laser light 202 can be changed in a time of approximately several tens of ns to several hundreds of ns.

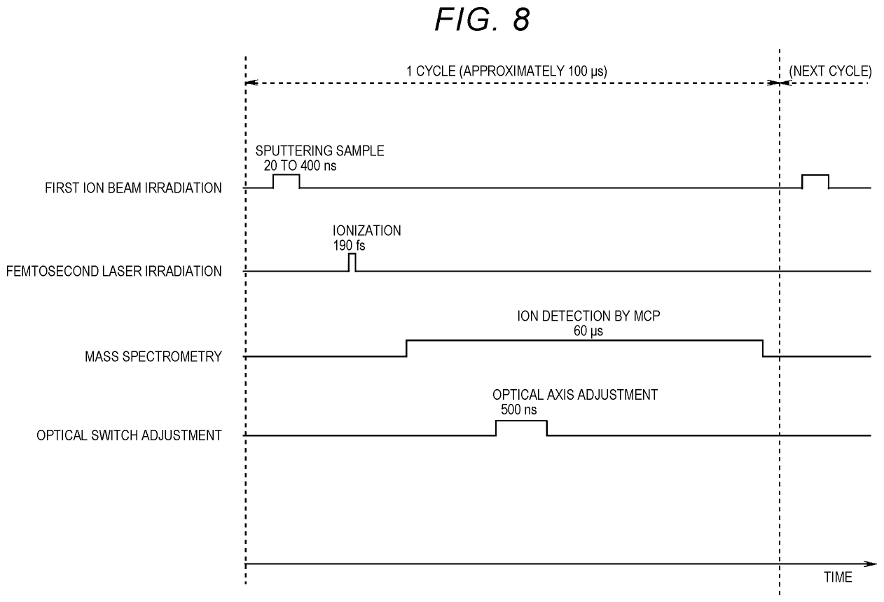

FIG. 8 is a timing chart of the operation of each part in the mass spectrometer of the embodiment. In FIG. 8, the horizontal axis indicates time. In the mass spectrometer 1 of the embodiment, first, in the first 20 ns to 400 ns, the sample 100 is sputtered by irradiating the observation region 100a with the ion beam 201 to release the particles. During the subsequent approximately 190 fs, the laser light 202 is emitted to ionize the released particles. Thereafter, the ion particles are detected in the mass spectrometry unit 30 during approximately 60 μs. As described above, it takes approximately 100 us to analyze one spot 201r in the observation region 100a. The mass spectrometer 1 of the embodiment can change the position of the irradiation region 202r of the laser light 202 in, for example, approximately 500 ns. Therefore, the position of the irradiation region 202r can be changed while the ion particles are detected by the mass spectrometry unit 30. As described above, in the mass spectrometer 1 of the embodiment, while the analysis is performed on one spot 201r, the position of the irradiation region 202r can be changed to the position of the next spot 201r. Therefore, a wide range of analysis can be performed without increasing the analysis time.

In addition, in the mass spectrometer of the comparative example, when the mirror 223 is significantly moved, there is a concern that a reflectance of the laser light 202 may change or a coherency may change. As a result, since the intensity of the laser light 202 emitted onto the observation region 100a is decreased, the ionization rate of the particles may be decreased, and therefore the detection sensitivity may be reduced. In contrast, in the mass spectrometer 1 of the embodiment, the low-resistance electro-optical crystal 221a is used, so that the reflectance of the laser light 202 and the change in the coherency are less likely to occur. As a result, the intensity of the laser light 202 that is emitted onto the observation region 100a is less likely to decrease, and thus it is possible to prevent the decrease in the detection sensitivity due to the decrease in the ionization rate of the particles.

In the above description, the beam irradiation unit 10 is configured to emit one ion beam 201, but may be configured to emit a plurality of ion beams at the same time, and may be configured to emit each of the plurality of spots 201r with the ion beam.

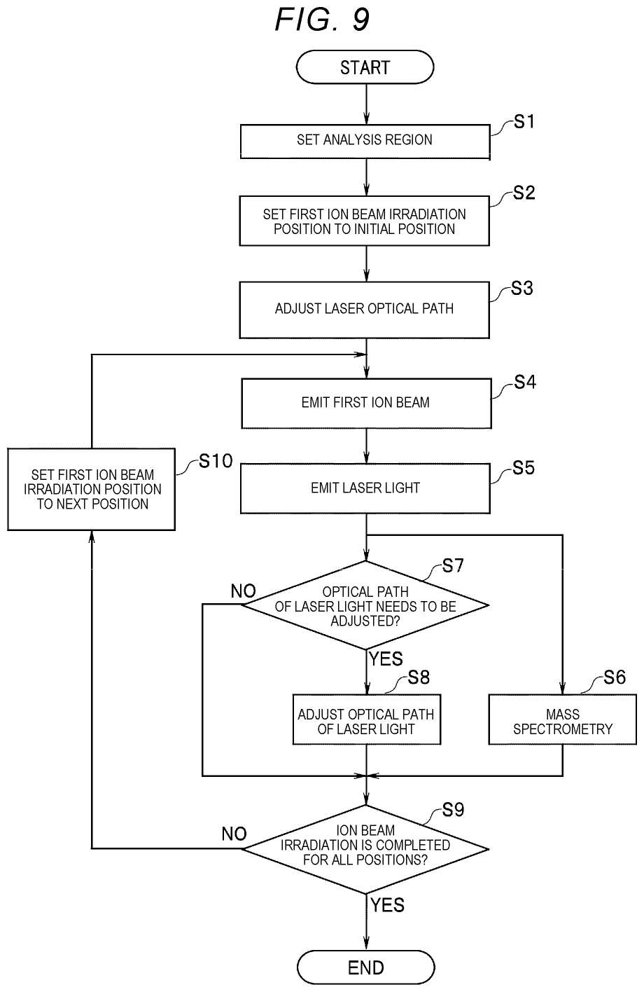

Next, an analysis method using the mass spectrometer 1 of the embodiment will be described with reference to FIG. 9. FIG. 9 is a flowchart showing an example of a procedure of an analysis method using the mass spectrometer of the embodiment. First, the observation region 100a serving as an analysis target region is set in the surface of the sample 100 (S1). Next, the irradiation position of the ion beam 201 is set to the initial position (S2). For example, in a case of the observation region 100a shown in FIG. 2, the spot 201r at the upper left end is set as the initial irradiation position. Subsequently, the optical path of the laser light 202 is adjusted such that the irradiation region 202r overlaps the position of the spot 201r set in S2 (S3). Then, the sample 100 is sputtered by irradiating the position of the spot 201r set in S2 with the ion beam 201 to release the particles (S4). Subsequently, the laser light 202 is emitted to ionize the particles released in S4 (S5).

Next, the particles (including neutral particles and ion particles) released in S4 are drawn into the mass spectrometry unit 30, and mass spectrometry is performed (S6). In parallel with S6, it is determined whether the optical path of the laser light 202 needs to be adjusted (S7). When the position of the current irradiation region 202r is shifted from the position of the next spot 201r to be set and the optical path needs to be adjusted (S7, YES), the optical path of the laser light 202 is adjusted in parallel with S6 (S8). Meanwhile, when the laser light 202 optical path does not need to be adjusted (S7, NO), S8 is not executed, and S9 is executed after S6 is completed.

When the mass spectrometry of S6 is completed and the optical path adjustment of S8 is also completed (when S8 is executed), it is determined whether an entire observation region 100a is irradiated with the ion beam 201 (S9). When there is a region that is not irradiated with the ion beam 201 (S9, NO), the irradiation position of the ion beam 201 is set to the next position (S10), and the series of procedures from S4 to S9 are repeated. When the entire observation region 100a is irradiated with the ion beam 201 (S9, YES), the analysis of the sample 100 is completed.

As described above, according to the analysis method of the embodiment, when the analysis of the observation region 100a is performed while moving the position of the spot 201r, the optical path of the laser light 202 is adjusted to the position of the next spot 201r while the mass spectrometry is performed on one spot 201r. Therefore, it is possible to perform wide-range analysis without increasing the detection time by preventing a decrease in the detection sensitivity.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A mass spectrometer comprising:
a beam irradiator configured to emit an ion beam with pulses to irradiate a beam irradiation region along a surface of a sample;
a laser irradiator configured to emit laser light with pulses to irradiate a laser irradiation region above the sample;
a mass spectrometry unit configured to detect a mass of ion particles released from the sample by the ion beam and ionized by the laser light; and
a controller configured to:
adjust a position of the laser irradiation region for each irradiation interval of the laser light.

2. The mass spectrometer according to claim 1,
wherein a position of the beam irradiation region is changed for each irradiation interval of the ion beam, and
the controller is configured to adjust the position of the laser irradiation region based on the change in the position of the beam irradiation region.

3. The mass spectrometer according to claim 2,
wherein the laser irradiator has a light source configured to emit the laser light and an optical path adjustment unit configured to change an optical path of the laser light, and
the optical path adjustment unit includes an electro-optical effect switch and an aspherical lens.

4. The mass spectrometer according to claim 3,
wherein the controller is configured to adjust the position of the laser irradiation region such that the laser irradiation region overlaps the beam irradiation region.

5. The mass spectrometer according to claim 3,
wherein the controller is configured to adjust the position of the laser irradiation region while the mass spectrometry unit detects the mass of the ion particles.

6. The mass spectrometer according to claim 1, wherein a width of the pulses of the laser light is approximately 100 fs.

7. A method, comprising:
emitting an ion beam with pulses to irradiate a beam irradiation region along a surface of a sample;
emitting laser light with pulses to irradiate a laser irradiation region above the sample;
detecting a mass of ion particles released from the sample by the ion beam and ionized by the laser light; and
adjusting a position of the laser irradiation region for each irradiation interval of the laser light.

8. The method according to claim 7, wherein a position of the beam irradiation region is changed for each irradiation interval of the ion beam, the method further comprises:
adjusting the position of the laser irradiation region based on the change in the position of the beam irradiation region.

9. The method according to claim 8, further comprising:
adjusting the position of the laser irradiation region such that the laser irradiation region overlaps the beam irradiation region.

10. The method according to claim 8, further comprising:
adjusting the position of the laser irradiation region while detecting the mass of the ion particles.

11. The method according to claim 7, wherein a width of the pulses of the laser light is approximately 100 fs.
